(19) United States
(12) Patent Application Publication
(10) Pub. No.: US 2021/0063222 A1
(43) Pub. Date: Mar. 4, 2021

(54) Monitor for a Flowmeter

(71) Applicant: Intel Corporation, Santa Clara, CA (US)

(72) Inventors: Tesfu Solomon, Portland, OR (US); Mark K. Behbehani, Portand, OR (US); Gordon R. Leeman, Chandler, AZ (US); Kevin J. Shelby, Chandler, AZ (US); John Flood, Leixlip (IE)

(21) Appl. No.: 17/014,740

(22) Filed: Sep. 8, 2020

Related U.S. Application Data
(63) Continuation of application No. 15/860,595, filed on Jan. 2, 2018.

(51) Int. Cl. G01F 15/06; G01F 1/00

(52) U.S. Cl. CPC G01F 15/063; G01F 1/005

(57) ABSTRACT

Components, devices, systems, and methods for monitoring a flowmeter. A transmitter may be configured to transmit a signal through a flowmeter. A sensor may be configured to receive the signal when the signal is unimpeded by a float in the flowmeter. A position of the float within the flowmeter may be determined based on sensor data from the sensor.

### BACKGROUND

Fluid or gas that moves through a pipe, tube or other container may move with a rate of flow. The rate of flow or movement of the fluid may be measured by a flowmeter. The measurement may be measured in volumetric or mass flow rates. One type of flowmeter may be a variable area meter that is a meter that measures fluid flow by allowing the cross sectional area of the device to vary in response to the flow. An example of a variable area meter may be a rotameter. A flowmeter may have a float in a tube where the flow is visible to the human eye. Marks may be made on the tube surrounding the float that indicates the flow rate when the float is in alignment with one of the marks. The flowmeter may be read by a user visibly inspecting the location of the float in the flowmeter. For a facility with a plurality of flowmeters, it may be time consuming for a user to visually inspect each of the plurality of flowmeters. Additionally, a flowmeter may be located in an area within the facility that is difficult for a person to gain access to.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIGS. 1A and 1B are block diagrams of a side view of a flowmeter with a monitor in accordance with an example embodiment;

FIG. 2 is a block diagram of a side view of a flowmeter and a monitor with an array of transmitters and array of sensors in accordance with an example embodiment;

FIG. 3 is a block diagram of a top view of a flowmeter with a monitor in accordance with an example embodiment;

FIG. 4 is a flow diagram of a method for monitoring a flowmeter in accordance with an example embodiment;

FIG. 5 is a block diagram of an example computer system with an electronic device package in accordance with another example embodiment.

### DESCRIPTION OF EMBODIMENTS

Before invention embodiments are described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for describing particular examples or embodiments only and is not intended to be limiting. The same reference numerals in different drawings represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details are provided, such as examples of layouts, distances, network examples, etc., to convey a thorough understanding of various invention embodiments. One skilled in the relevant art will recognize, however, that such detailed embodiments do not limit the overall inventive concepts articulated herein, but are merely representative thereof.

As used in this written description, the singular forms “a,” “an” and “the” include express support for plural referents unless the context clearly dictates otherwise. Thus, for example, reference to “an integrated circuit” includes a plurality of such integrated circuits.

Reference throughout this specification to “an example” means that a particular feature, structure, or characteristic described in connection with the example is included in at least one invention embodiment. Thus, appearances of the phrases “in an example” or “in an embodiment” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various invention embodiments and examples can be referred to herein along with alternatives for the various components thereof. It is understood that such embodiments, examples, and alternatives are not to be construed as de facto equivalents of one another, but are to be considered as separate and autonomous representations under the present disclosure.

Furthermore, the described features, structures, or characteristics can be combined in any suitable manner in one or more embodiments. In the following description, numerous specific details are provided, such as examples of layouts, distances, network examples, etc., to provide a thorough understanding of invention embodiments. One skilled in the relevant art will recognize, however, that the technology can be practiced without one or more of the specific details, or with other methods, components, layouts, etc. In other instances, well-known structures, materials, or operations may not be shown or described in detail to avoid obscuring aspects of the disclosure.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open ended term in this written description, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

The term “coupled,” as used herein, is defined as directly or indirectly connected in an electrical or nonelectrical manner. “Directly coupled” objects or elements are in physical contact with one another. Objects described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, comparative terms such as “increased,” “decreased,” “better,” “worse,” “higher,” “lower,” “enhanced,” and the like refer to a property of a device, component, or activity that is measurably different from other devices, components, or activities in a surrounding or adjacent area, in a single device or in multiple comparable devices, in a group or class, in multiple groups or classes, or as compared to the known state of the art. For example, a data region that has an “increased” risk of corruption can refer to a region of a memory device, which is more likely to have write errors to it than other regions in the same memory device. A number of factors can cause such increased risk, including location, fabrication process, number of program pulses applied to the region, etc.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases, depend on the specific context. However, generally speaking, the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided.

Numerical amounts and data may be expressed or presented herein in a range format. It is to be understood, that such a range format is used merely for convenience and brevity, and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

This same principle applies to ranges reciting only one numerical value as a minimum or a maximum. Furthermore, such an interpretation should apply regardless of the breadth of the range or the characteristics being described.

As used herein, the term “circuitry” can refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some aspects, the circuitry can be implemented in, or functions associated with the circuitry can be implemented by, one or more software or firmware modules. In some aspects, circuitry can include logic, at least partially operable in hardware.

Various techniques, or certain aspects or portions thereof, may take the form of program code (i.e., instructions) embodied in tangible media, such as floppy diskettes, compact disc-read-only memory (CD-ROMs), hard drives, transitory or non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a random-access memory (RAM), erasable programmable read only memory (EPROM), flash drive, optical drive, magnetic hard drive, solid state drive, or other medium for storing electronic data. The node and wireless device may also include a transceiver module (i.e., transceiver), a counter module (i.e., counter), a processing module (i.e., processor), and/or a clock module (i.e., clock) or timer module (i.e., timer). One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

As used herein, the term “processor” can include general purpose processors, specialized processors such as VLSI, FPGAs, or other types of specialized processors, as well as base band processors used in transceivers to send, receive, and process wireless communications.

It should be understood that many of the functional units described in this specification may have been labeled as modules, in order to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module may not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “an example” or “exemplary” means that a particular feature, structure, or characteristic described in connection with the example is included in at least one embodiment of the present technology. Thus, appearances of the phrases “in an example” or the word “exemplary” in various places throughout this specification are not necessarily all referring to the same embodiment.

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

Flowmeters may be employed to measure the rate of flow of a fluid or gas that moves through a container such as a pipe or tube. One example of a flowmeter may be a rotameter where a weighted “float” rises in a tapered tube as the flow rate increases. The float stops rising when an area between float and tube is large enough that the weight of the float is balanced by the drag of fluid flow. The tapered tube may be transparent such that a user may visually inspect the location of the float within the tapered tube. Measurement marks such as tick marks may be placed on the tapered tube or a transparent tube that houses the tapered tube. A given measurement mark may indicate the rate of flow when the float is positioned next to the given measurement mark.

A facility may contain a large number of flowmeters that are read by a user. The flowmeters may be located in areas within the facility that are difficult to gain access to. For example, a flowmeter may be placed on top of a fluid tank and may require a user to employ a ladder to be in a position to read the float in the flowmeter. Visually inspecting a flowmeter to obtain data regarding the rate of flow may be time consuming and potentially dangerous. A sensor may be placed inside a flowmeter to automatically measure the rate of flow in the flowmeter. However, installing a sensor inside a flowmeter that is already deployed in the field may require that the flowmeter be taken offline and dismantled. This is costly and a disruption to the facility as a whole that employs the flowmeter.

Embodiments of the present technology are employed to remotely monitor the rate of flow in a flowmeter. The present technology may be used with or installed on a flowmeter that is already deployed in the field without requiring the flowmeter to be taken offline or dismantled. The present technology may be a transmitter in a first housing that transmits a signal across the flow meter. The signal may be received by a sensor that is in a second housing mounted to the flowmeter opposite of the first housing. When the signal is unimpeded by a float in the flowmeter then the signal will be received by the sensor. When the signal is blocked by the float then a determination is made regarding a position of the float within the flowmeter. Data regarding the determination may be sent to a remote location to monitor the rate of flow measured by the flowmeter. The signals generated and sent by the transmitter may be light. For example, the transmitter may be a light emitting diode (LED) or a laser. The sensor may be capable of detecting the light from the transmitter and may be a device such as a phototransistor. The transmitter may also be capable of generating sound such as ultrasonic sound that is detectable by the sensor.

In one example, each transmitter in an array of transmitters sends a signal across a flowmeter to be received by an array of corresponding sensors. When a float in the flowmeter blocks a given signal from one of the transmitters to the corresponding sensor, then a determination is made that the float is located in a position that corresponds to the transmitter and sensor that have a blocked signal. While the float is blocking the given signal, the signals received by the other sensors in the array may be unimpeded by the float.

The transmitters and sensors may be placed in a first and second housing respectively. The first and second housing may be mounted or otherwise attached to a flowmeter. In one example, the first and second housing may be mounted to an existing flowmeter already in use in the field. In one example, the sensors and transmitters are built into the flowmeter at the time of manufacture. The sensors and transmitters may be connected with devices and components used for control and to gather data from the sensors. For example, a driver may be employed to drive current through the transmitters to turn the transmitters on and off. The sensors may be connected to a processor and memory for storing data generated by the sensors. The data may be sent using a communications device to a central location. For example, the communications device may employ wireless protocols for sending the data. The central location may be remote to the flowmeter and may be located within a facility that receives data from a plurality of flowmeters. Thus the present technology may be employed to remotely monitor a plurality of flowmeters.

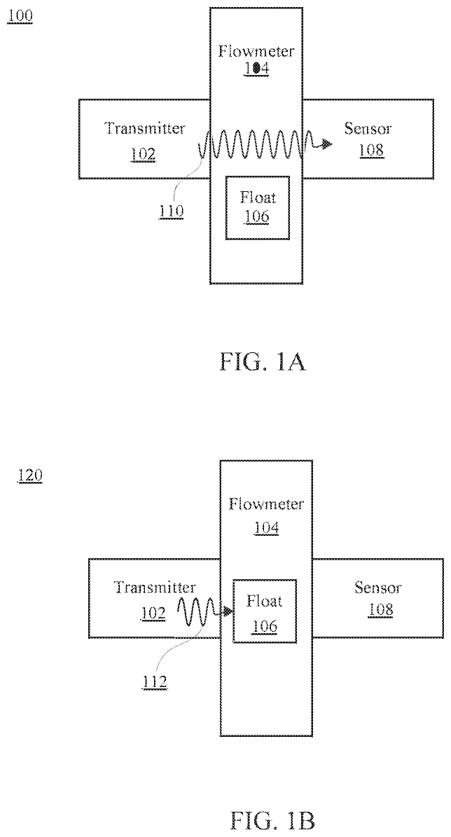

FIG. 1A is a block diagram illustrating environment 100 of a flowmeter 104 with a monitor in accordance with embodiments of the present technology. Environment 100 includes the flowmeter 104 with a float 106. The flowmeter 104 may be a rotameter and may have a tapered tube to house the float 106. The float 106 will change positions within the flowmeter 104 indicating the rate of flow of the fluid or gas that is moving through the flowmeter 104. A transmitter 102 may be attached, coupled or mounted to the flowmeter 104. The transmitter 102 is configured to transmit a signal 110 through the flowmeter 104. The transmitter 102 may be any one of a variety of transmitters. For example, the transmitter 102 may be a light emitting diode (LED), a laser, or other light emitting device and the signal 110 may be electromagnetic radiation such as light. The light may be infrared, visible, or ultra violet light. A sensor 108 may be capable of detect or sensing the signal 110 as light. For example, the sensor 108 may be a phototransistor.

The transmitter 102 and the sensor 108 may be described as a pair such as a source and detected pair. The transmitter 102 and the sensor 108 are positioned on opposite sides of the flowmeter 104 such that the signals generated by the transmitter 102 will be sent through the flowmeter 104 and received by the sensor 108. The transmitter 102 and the sensor 108 may be positioned at the same vertical position along a length of the flowmeter 104. The vertical position may be associated with a volumetric flow rate of the fluid or gas associated with the flowmeter 104. For example, the vertical position may be associated with 2 cubic meters per second or any other measurement that the flowmeter 104 is capable of measuring. The transmitter 102 may transmit the signal perpendicular to the length of the flowmeter 104.

In one aspect, the transmitter 102 may be capable of generating an acoustic signal. For example, the transmitter 102 may be an ultrasonic transducer that is capable of generating the signal 110 as an acoustic signal. The sensor 108 may be capable of detecting or sensing the acoustic signal. It should be appreciated that the transmitter 102 may employ other types of technologies for generating the signal 110 that is sent through a liquid or gas in the flowmeter 104 where the sensor 108 is capable of detecting the signal 110 when the signal 110 is unimpeded by the float 106.

The environment 100 depicts the transmitter 102 sending the signal 110 through the flowmeter 104. In environment 100 the float 106 is positioned in the flowmeter 104 below the transmitter 102 and the sensor 108. With the float 106 in this position, the signal 110 from the transmitter 102 is unimpeded by the float 106 and the sensor 108 is able to receive and detect the signal 110. The sensor 108 may generate sensor data regarding whether the signal 110 is received or not. The sensor data may be sent to a controller associated with the flowmeter 104. The controller may then use the sensor data to determine a position of the float 106 in the flowmeter 104. The position of the float 106 may be sent to a central location using a communication device associated with the flowmeter 104 and the controller. With only one transmitter and sensor pair depicted in environment 100, the controller may not be able to determine the exact position of the float 106 and may only determine that the float 106 is not in a position associated with the transmitter 102 and the sensor 108. In one aspect, the controller may not determine the position of the float 106 and instead may send the raw sensor data to the remote location.

FIG. 1B is a block diagram illustrating environment 120 of the flowmeter 104 with a monitor in accordance with embodiments of the present technology. Environment 120 depicts an environment where the float 106 is positioned within the flowmeter 104 such that the float 106 will block a signal 112 generated by the transmitter 102. When the float 106 blocks the signal 112 then the sensor 108 will not be able to detect the signal 112. The sensor 108 may generate sensor data that the signal 112 is not detected and the sensor data may be sent to a controller. The controller may determine that the float 106 is at a position associated with the transmitter 102 and the sensor 108 because the float 106 is blocking the signal 112.

The transmitter 102 may be configured to periodically send a signal, such as the signal 110 or the signal 112, through the flowmeter 104. For example, the transmitter 102 may send a signal every 10 minutes, every 30 seconds, or any other predetermined amount of time. The sensor 108 may be configured to receive the signal from the transmitter 102 only when a signal is being sent. Thus the transmitter 102 will not continuously send a signal. The periodic sending of signals by the transmitter 102 is more efficient than continuously sending a signal and saves power. In one aspect, the transmitter 102 is configured to continuously send a signal through the flowmeter 104.

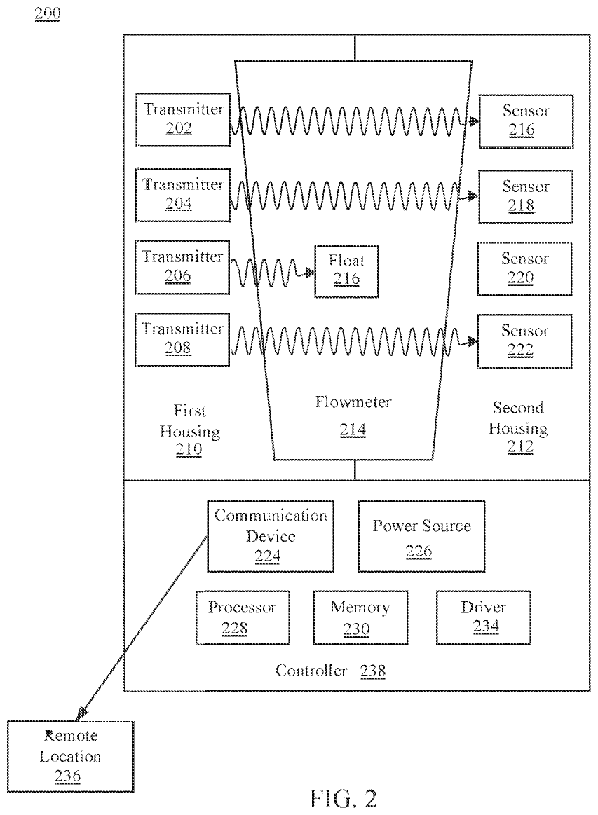

FIG. 2 is a block diagram illustrating environment 200 of a flowmeter 214 with a monitor that has an array of transmitters and an array of sensors. The environment 200 includes transmitters 202, 204, 206, and 208, the flowmeter 214, a float 216, and sensors 216, 218, 220, and 222 which may have the same capabilities and features of the transmitter 102, the flowmeter 104, the float 106, and the sensor 108 of FIG. 1 respectively. Environment 200 also includes a controller 238 and a remote location 236. The controller 238 may include a communication device 224, a power source 226, a processor 228, a memory 230, and a driver 234. The flowmeter 214 is depicted as having a tapered shape that is wider on the top than on the bottom. It should be appreciated that the present technology may be practiced using a flowmeter that is tapered in shape or that employs any other shape.

The monitor for the flowmeter 214 may include an array of the transmitters 202, 204, 206, and 208 and an array of the sensors 216, 218, 220, and 222. The transmitters 202, 204, 206, and 208 may be housed in the first housing 210. The sensors 216, 218, 220, and 222 may be housed in a second housing 212. The first housing 210 and the second housing 212 may be described as a housing, a holder, a framework, a mounting device, etc. The first housing 210 and the second housing 212 are designed to mount, attach, or couple to the flowmeter 214. For example, the flowmeter 214 may be an existing flowmeter 214 that is already deployed in the field. The first housing 210 and the second housing 212 may be mounted to the flowmeter 214 without uninstalling or otherwise taking the flowmeter 214 offline. Thus the first housing 210 and the second housing 212 may be mounted to the float 216 without disrupting the flowmeter 214 or disrupting a larger system that the flowmeter 214 may be a part of. In one aspect, the flowmeter 214 is manufactured with the first housing 210 and the second housing 212 mounted to the flowmeter 214. This may be described as the flowmeter 214 being integrated with the first housing 210 and the second housing 212 at the time of manufacture. The first housing 210 and the second housing 212 may be easily removable from the flowmeter 214. The first housing 210 and the second housing 212 are depicted as two separate objects that are touching at the top and the bottom of the flowmeter 214. In one aspect, the first housing 210 and the second housing 212 may be one piece. In one aspect, the first housing 210 and the second housing 212 do not touch one another when mounted to the flowmeter 214. The first housing 210 and the second housing 212 may be composed of any type of suitable material including plastics and metals. The first housing 210 and the second housing 212 may be fastened to one another using screws or other fasteners.

The first housing 210 and the second housing 212 may be mounted to the flowmeter 214 such that a portion of the flowmeter 214 is still visible to the human eye. For example, a flowmeter 214 may be transparent and have measurement marking placed vertically along a length of the flowmeter 214. The first housing 210 and the second housing 212 may be mounted to the flowmeter 214 such that a human user is still able to see the measurement marks of the flowmeter 214 and manually determine a rate of flow of the flowmeter 214 by visually inspecting a location of the float 216 within the flowmeter 214. In one aspect, the first housing 210 and the second housing 212 are coupled to or otherwise attached to the controller 238. It should be appreciated that the controller may not be physically touching the first housing 210 or the second housing 212. The controller 238 may be a printed circuit board (PCB). In one aspect, the controller 238 is a MoteinoMEGA board. The first housing 210 and the second housing 212 may each comprise a custom PCB to house the transmitters 202, 204, 206, and 208 and the sensors 216, 218, 220, and 222 respectively.

The array of the transmitters 202, 204, 206, and 208 may correspond to the array of the sensors 216, 218, 220, and 222. For example, the transmitter 202 may correspond to the sensor 216 and may be described as a pair where the transmitter 202 is a source and the sensor 216 is a detector. Each transmitter may have a corresponding sensor. Transmitter 202 may correspond to sensor 216, transmitter 204 may correspond to sensor 218, transmitter 206 may correspond to sensor 220, and transmitter 208 may correspond to sensor 222. Each transmitter and sensor pair may be placed in a vertical position along the flowmeter 214 that corresponds with a measurement mark of the flowmeter 214. Each transmitter may send a signal to the corresponding signal, as depicted. When the float 216 impedes or blocks the signal from a given transmitter to the corresponding sensor, then the location of the float 216 may be determined. For example, the environment 200 depicts the transmitters 202, 204, and 208 each sending a signal that is received by the sensors 216, 218, and 222 respectively. Therefore, the controller 238 can infer that the float 216 is not located in a position associated with the transmitters 202, 204, and 208. However, the signal sent by the transmitter 206 to the sensor 220 is blocked by the float 216. Therefore, the controller 238 can infer that the position of the float 216 is located in a position associated with the transmitter 206 and the sensor 220. With an array of sensor and transmitters the controller 238 is capable of determining where the float is located and where the float is not located.

The first housing 210 is depicted as housing the array of the transmitters 202, 204, 206, and 208 while the second housing 212 is depicted as housing the array of the sensors 216, 218, 220, and 222. However, the first housing 210 or the second housing 212 may house a combination of sensors and transmitters. For example, the first housing 210 may house an array of both transmitters and a sensors where the location of the sensors and transmitter alternates meaning that a transmitter may be placed at the top of the first housing 210 and the next position down houses a sensor, then the next position down houses a transmitter, and so on. Each sensor in the first housing 210 has a transmitter located in the same vertical position across the flowmeter 214 in the second housing 212. Each transmitter in the first housing 210 has a sensor located in the same vertical position across the flowmeter 214 in the second housing 212. Thus each transmitter has a corresponding sensor located across the flowmeter and vice versa. By alternating transmitters and sensors within the same housing, a given sensor is less likely to receive or detect a signal from a transmitter that is not corresponding to the given sensor. Alternating transmitters and sensors within the same housing may be useful for a small flowmeter.

The number of transmitter and sensor pairs may be increased to increase the resolution in determining the exact position of the float 216 within the flowmeter 214. In other words, more transmitter and sensor pairs lead to greater accuracy. Environment 200 depicts four transmitter and sensor pairs. It should be appreciated that any number of transmitter and sensor pairs may be employed to monitor a flowmeter. The transmitter and sensor pairs may be spaced vertically relative to one another using a predetermined amount of space. In one aspect, this predetermine amount of space may be optimized by making the detectable spacing between the sensors equal to half of the physical or vertical spacing of the sensors. For example, the float 216 may have a vertical height that is ½+n of the predetermined amount of spacing between the sensors. In this configuration the top of the float 216 while moving upward would break a beam from a transmitter, such as the transmitter 202, and the bottom of the float 216 releases the beam from the transmitter 204 that would be out of phase.

The controller 238 may include the power source 226. The power source 226 may be located in a housing associated with the controller 238 or may be external to the controller 238. The power source 226 may be any type of power source including, but not limited to, an electrical wall outlet, a battery, a solar panel, etc. The power source 226 may power the controller 238 including internal components of the controller 238 as well as the transmitters 202, 204, 206, and 208 and the sensors 216, 218, 220, and 222. The controller 238 may be able to detect if a battery associated with the power source 226 has a low power level. The controller 238 may then send a notification that the battery is low.

The controller 238 may include the driver 234. The driver 234 may be configured to send electrical signals or current to the transmitters 202, 204, 206, and 208 to control the signals generated and sent by the transmitters 202, 204, 206, and 208. For example, if the driver 234 may drive the transmitters to continuously send signals or to periodically send signals. The driver 234 may be used to determine the length and intensity of the signals sent. In one aspect, the driver 234 is a metal-oxide-semiconductor field-effect transistor (MOSFET) or a programmable reference resistor. In one aspect, the driver 234 in conjunction with other components of the controller 238 is configured to detect current changes in a given transmitter. For example, if the transmitter 202 is an LED, then the driver 234 may track current changes in the transmitter 202 and the processor 228 is then used to determine that the LED for the transmitter 202 needs to be replaced soon. A notification may be sent to notify a user that the LED should be replaced.

The controller 238 may include the processor 228 and the memory 230. The processor 228 may be a processor that is capable of receiving the sensor data from the sensors 216, 218, 220, and 222 and use the sensor data to determine a location of the float 216 in the flowmeter 214. The processor 228 may store sensor data or float location data in the memory 230. The memory 230 may be any type of persistent storage for storing electronic data.

The controller 238 may include the communication device 224. The communication device 224 may be configured to send data transmissions to a remote location 236. The data transmissions may include the sensor data from the sensors and may also include data regarding determination made by the controller 238 about the location of the float 216. The data transmissions may also include current changes detected by the driver 234. The communication device 224 may be capable of sending data transmissions over a physical wire or wirelessly. For example, the communication device 224 may use WiFi, Bluetooth, LoRa radio, Ethernet, near field communications, radio signals, cellular signals, or other protocols and technologies for sending data. Wireless embodiments of the communication device 224 may have a range for sending the wireless signals such as 300 feet. The range may be intentionally limited to extend or optimize the battery life of a battery associated with the power source 226. The communication device 224 may send data transmissions over a network such as a local network or the internet. Sending the data transmissions on a periodic basis may prolong or optimize battery life of a battery associated with the power source 226. For example, the data transmissions may be sent on a periodic basis of every 10 minutes which may allow a batter to last 4.5 years before replacement is needed. In one aspect, the communication device 224 is capable of receiving incoming data transmissions for a source such as the remote location 236. The incoming data transmissions may update, modify, remove, install, or uninstall software or firmware associated with the controller 238. The incoming data transmissions may be commands for the controller 238 regarding the predetermined amounts of time the transmitters are to send the signals on a periodic basis.

The remote location 236 may be a central control or command center associated with a facility. For example, a facility may have hundreds or thousands of flowmeters that each has a monitor associated with the present technology mounted to monitor the respective floats of the flowmeters. The remote location 236 is able to receive data transmissions from the communication devices associated with each respective flowmeter. The data transmission may be a determination regarding the location of the respective floats or may be raw sensor data gathered by controllers associated each flowmeter. The remote location 236 may be able to use the raw sensor data to determine a position of a float within a given flowmeter. In one example, the remote location 236 is a gateway such as a LoRa gateway. Such a gateway may be associated with a control system such as supervisory control and data acquisition (SCADA) system. The gateway may employ custom LoRa to JavaScript Object Notation (JSON) firmware. The SCADA system may employ an E100 with Python JSON to Message Queuing Telemetry Transport (MQTT) code. Thus the remote location 236 may be able to receive data to track a plurality of flowmeters remotely. The remote location 236 may be located physically close to the flowmeter or may be located anywhere in the world. The remote location may be stationary or may be mobile. For example, a mobile remote location 236 may be mobile electronic device that is moved within range of the wireless capabilities of the communication device 224. Thus, a remote location 236 that is mobile may be moved throughout a facility to capture data from a plurality of flowmeters. The memory 230 may be used by the controller to store data regarding a plurality of locations of the float 216 that are detected over a period of time. The communication device 224 may then send data to the remote location 236 that has been stored for a period of time. For example, the controller 238 over the period of an hour may control the transmitters 202, 204, 206, and 208 to send signals every five minutes. Sensor data may be collected from the sensors 216, 218, 220, and 222 every five minutes during the hour when the signals are sent thus totaling twelve sets of sensor data. The twelve sets of sensor data for the hour may be stored in the memory 230 and then be sent all at once to the remote location 236 from the communication device 224.

In one aspect, the remote location 236 is configured to generate an alarm based on position of the float in a given flowmeter. For example, the parameters may be set for the given flowmeter regarding normal or acceptable flow rates such that if a float is within a range of positions designated by the parameters then no alarm is generated. But if the position of the float is outside of the parameters then an alarm may be generated to notify a user that the flow rate for the given flowmeter is out of the parameters. The parameters and alarms may be adjusted or modified by a user.

In one aspect, the signals from transmitters 202, 204, 206, and 208 are light from a laser. In one example, each of the transmitters 202, 204, 206, and 208 may be a laser. In one example, the transmitters 202, 204, 206, and 208 each transmit light from the same laser. For example, a single laser may be placed at or near the top or bottom of the first housing 210. The light from the single laser is then sent vertically through each of the transmitters 202, 204, 206, and 208. Each of the transmitters 202, 204, 206, and 208 then lets a portion of the light from the single laser pass through, but for a different portion of the light the direction of the light is changed perpendicular to be sent to the corresponding sensor. Thus one light source may be used to generate signals for the transmitters 202, 204, 206, and 208.

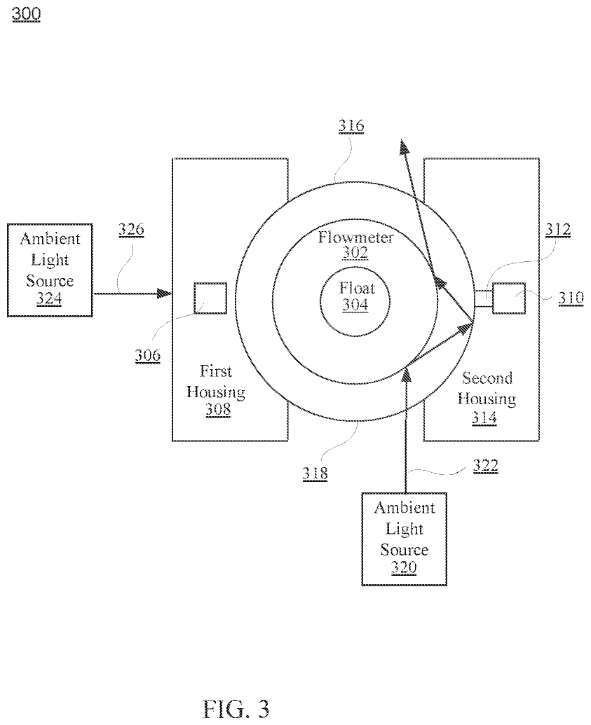

FIG. 3 is a diagram illustrating a top view of an environment 300 of a flowmeter 302 with a monitor. The environment 300 includes a transmitter 306, a flowmeter 302, a float 304, a first housing 308, a second housing 314, and a sensor 310 which may have the same features of the transmitters 202, 204, 206, and 208, the flowmeter 214, a float 216, and sensors 216, 218, 220, and 222, the first housing 210, and the second housing 212 of FIG. 2 and the transmitter 102, the flowmeter 104, the float 106, and the sensor 108 of FIG. 1 respectively.

The sensor 310 may be positioned in the second housing 314 such that the second housing 314 has an opening 310 for the sensor 310. The opening 310 allows the sensor 310 to be recessed within the second housing 314. When the sensor 310 is positioned in a recessed position within the second housing 314, the opening 310 is used to receive signals from the transmitter 306. The environment 300 may include an ambient light source 320. The ambient light source 320 may be any type of source of light including the sun, a light bulb, fluorescent light, infrared generators, etc. Ambient light generated by the ambient light source 320 may be detected by the sensor 310 and may be confused with signals generated by the transmitter 306. Recessing the sensor 310 within second housing 314 reduces the amount of light that may be received by the sensor 310. By reducing the ambient light received by the sensor 310, more accurate data regarding the position of the float 304 may be generated by the sensor 310.

The flowmeter 302 may be housed in an outer housing 316. The outer housing 316 may be transparent and may include measurement markings 318. The ambient light source 320 may send ambient light 322 through the outer housing 316. A portion of the light from the ambient light source 320 may pass straight through the outer housing 316 and the flowmeter 302. A different portion of the light from the ambient light source 320, such ambient light 322, may pass through the outer housing 316 and reflect off of the surface of the flowmeter 302 and then impinge on a surface of the second housing 314. If the sensor 310 were to be located on the surface of the second housing 314, then the ambient light 322 may impinge on the sensor 310. However, if the sensor 310 is recessed in the second housing 314, as depicted, then the ambient light 322 may reflect between the flowmeter 302 and the second housing 314 until the ambient light 322 exits the flowmeter 302 and outer housing 316 in a direction away from the sensor 310, as depicted in environment 300. Thus the sensor 310 recessed in the second housing 314 may receive a reduced amount of ambient light.

Ambient light 326 from ambient light source 324 may also be able to penetrate through the flowmeter 302 and impinge on the sensor 310. To block the ambient light 326, the first housing 308 may be designed and built to be of sufficient thickness and of a material that will block the ambient light 326. Thus the first housing 308 may be much wider than the transmitter 306. This allow the first housing 308 to act as a shield to block the ambient light 326 from passing through the flowmeter 302 and impinging on the sensor 310.

As depicted in environment 300, the measurement markings 318 may be visible to the human eye after the first housing 308 and the second housing 314 have been mounted to the flowmeter 302. Thus the monitor for the present technology may be employed to remotely monitor a flowmeter while still allowing a human user to visually determine the position of a float within a flowmeter.

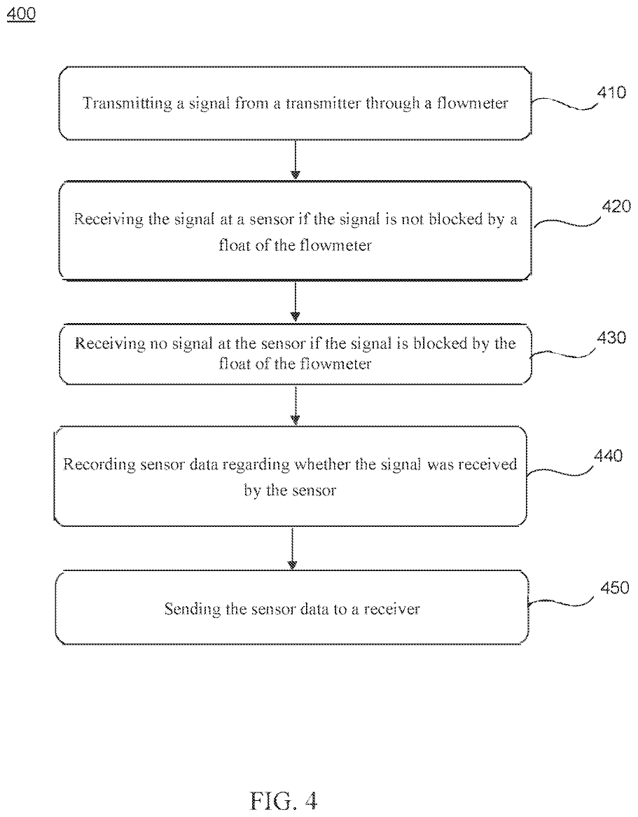

FIG. 4 illustrates a flow diagram of methods or operations for monitoring a location of a float in a flowmeter in accordance with embodiments of the present technology. The monitor and flowmeter may be the components depicted in FIGS. 1A, 1B, 2, and 3 respectively. For example, starting in block 410 a signal may be transmitted from a transmitter through a flowmeter. The signal is received at a sensor if the signal is not blocked by a float of the flowmeter, as in block 420. No signal is received at the sensor if the signal is blocked by the float of the flowmeter, as in block 430. Sensor data is recorded regarding whether the signal was received by the sensor, as in block 440. The sensor data is sent to a receiver, as in block 450.

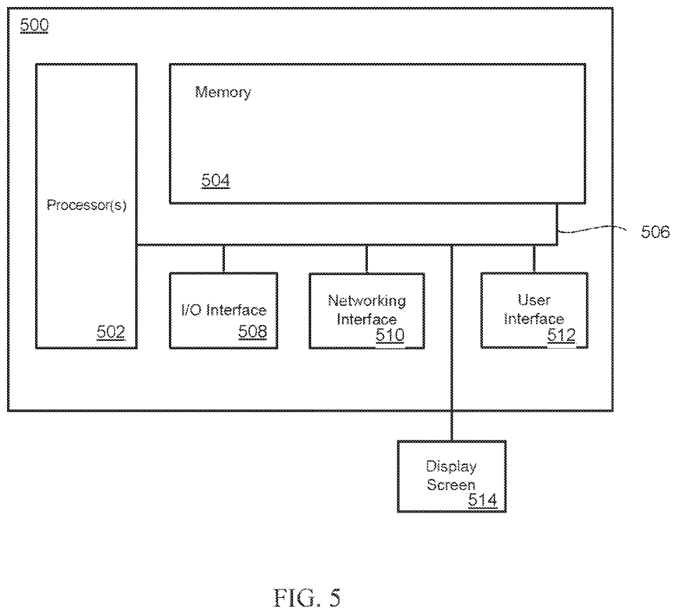

FIG. 5 depicts an exemplary system upon which embodiments of the present disclosure may be implemented. For example, the system of FIG. 5 may be a computer system at a remote location that receives communication signals from a communication device associated with the flowmeter monitor. Components of the system of FIG. 5 may be used for the monitor of the flowmeter. For example, the processor 228 of FIG. 2 may be the same as processor 502. The system can include a memory controller 502, a plurality of memory 504, a processor 506, and circuitry 508. The circuitry can be configured to implement the hardware described herein for the testing device 102 or the integrated circuits of FIGS. 1A-C. Various embodiments of such systems for FIG. 5 can include smart phones, laptop computers, handheld and tablet devices, CPU systems, SoC systems, server systems, networking systems, storage systems, high capacity memory systems, or any other computational system.

The system can also include an I/O (input/output) interface 510 for controlling the I/O functions of the system, as well as for I/O connectivity to devices outside of the system. A network interface can also be included for network connectivity, either as a separate interface or as part of the I/O interface 510. The network interface can control network communications both within the system and outside of the system. The network interface can include a wired interface, a wireless interface, a Bluetooth interface, optical interface, and the like, including appropriate combinations thereof. Furthermore, the system can additionally include various user interfaces, display devices, as well as various other components that would be beneficial for such a system.

The system can also include memory in addition to memory 504 that can include any device, combination of devices, circuitry, and the like that is capable of storing, accessing, organizing and/or retrieving data. Non-limiting examples include SANs (Storage Area Network), cloud storage networks, volatile or non-volatile RAM, phase change memory, optical media, hard-drive type media, and the like, including combinations thereof.

The processor 506 can be a single or multiple processors, and the memory can be a single or multiple memories. The local communication interface can be used as a pathway to facilitate communication between any of a single processor, multiple processors, a single memory, multiple memories, the various interfaces, and the like, in any useful combination.

The system can also include a user interface 512 a graphical user interface for interacting with the user. The system can also include a display screen 514 for displaying images and the user interface 512.

The disclosed embodiments may be implemented, in some cases, in hardware, firmware, software, or any combination thereof. Portions of the disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

### Examples

The following examples pertain to specific technology embodiments and point out specific features, elements, or steps that may be used or otherwise combined in achieving such embodiments.

In one example there is provided a component for monitoring a flowmeter, comprising: a transmitter configured to transmit a signal through a flowmeter; and a sensor configured to receive the signal when the signal is unimpeded by a float in the flowmeter.

In one example of a component for monitoring a flowmeter comprises, a communication device configured to send sensor data regarding whether the sensor received the signal or if the signal was blocked by the float.

In one example of a component for monitoring a flowmeter comprises, a memory configured to store sensor data regarding whether the sensor received the signal or if the signal was blocked by the float.

In one example of a component for monitoring a flowmeter comprises, a first housing configured to house the transmitter; and a second housing configured to house the sensor.

In one example of a component for monitoring a flowmeter, the sensor is recessed into the second housing to block ambient signals not originating from the transmitter.

In one example of a component for monitoring a flowmeter, the first housing and the second housing are configured to mount to an existing flowmeter without disconnecting the flowmeter.

In one example of a component for monitoring a flowmeter, the transmitter and the sensor are integrated into the flowmeter during the manufacture of the flowmeter.

In one example of a component for monitoring a flowmeter comprises, an array of a plurality of transmitters configured to transmit signals through the flowmeter, wherein each of the plurality of transmitters are positioned at a difference location on the flowmeter; and an array of a plurality of sensors configured to receive the signals through the flowmeter, wherein a position for each of the plurality of sensors correspond to one of the plurality of transmitters.

In one example of a component for monitoring a flowmeter, a position of the float is determined within the flowmeter based on data generated by the array of sensor

In one example of a component for monitoring a flowmeter, the transmitter and the sensor are positioned on the flowmeter such that a position of the float of the flowmeter is able to be visually read.

In one example of a component for monitoring a flowmeter, the transmitter is a Light Emitting Diode (LED) and the signal is light.

In one example of a component for monitoring a flowmeter, the transmitter is a laser and the signal is light.

In one example of a component for monitoring a flowmeter, the transmitter is an ultrasonic transmitter and the signal is sound.

In one example of a component for monitoring a flowmeter, the sensor is a phototransistor.

In one example of a component for monitoring a flowmeter, the signal is infrared (IR) light.

In one example of a component for monitoring a flowmeter, the flowmeter has a length and the signal is transmitted perpendicular to the length of the flowmeter.

In one example of a component for monitoring a flowmeter comprising, a driver configured to drive current through the transmitter.

In one example of a component for monitoring a flowmeter, the driver is a metal-oxide-semiconductor field-effect transistor (MOSFET) or a programmable reference resistor.

In one example of a component for monitoring a flowmeter, the driver is configured to track current changes in the transmitter.

In one example of a component for monitoring a flowmeter, the driver is configured to periodically drive the transmitter to send the signal through the flowmeter.

In one example there is provided a device for monitoring a flowmeter, comprising: an array of transmitters configured to transmit signals through a flowmeter; a first housing configured to house the array of transmitters; an array of sensors, each sensor in the array of sensors is configured to receive a signal from a corresponding transmitter in the array of transmitter when the signal is unimpeded by a float in the flowmeter; and a communication device configured to send sensor data generated by the array of sensors.

In one example of a device for monitoring a flowmeter, the transmitters are positioned along a length of the flowmeter and the sensors are positioned on an opposite side of the flowmeter corresponding to the transmitters such that the signals travel in a direction perpendicular to the length of the flowmeter.

In one example of a device for monitoring a flowmeter, the transmitters are positioned with a space in between one another where the space is the thickness of the float and sensor are spaced corresponding the transmitters.

In one example of a device for monitoring a flowmeter, the sensors are recessed into the second housing to block ambient signals not originating from the transmitters.

In one example of a device for monitoring a flowmeter, the first housing and the second housing are configured to mount to an existing flowmeter without disconnecting the flowmeter.

In one example of a device for monitoring a flowmeter, the first housing and the second housing are integrated into the flowmeter during the manufacture of the flowmeter.

In one example of a device for monitoring a flowmeter, the transmitters, the sensor, the first housing, and the second housing are positioned on the flowmeter such that a position of the float of the flowmeter is able to be visually read.

In one example of a device for monitoring a flowmeter, the transmitters are Light Emitting Diodes (LEDs) and the signals are light.

In one example of a device for monitoring a flowmeter, the transmitters are lasers and the signals are light.

In one example of a device for monitoring a flowmeter, the transmitters are ultrasonic transmitters and the signals are sound.

In one example of a device for monitoring a flowmeter, the sensors are phototransistors.

In one example of a device for monitoring a flowmeter, the signals are infrared (IR) light.

In one example of a device for monitoring a flowmeter comprises, a driver configured to drive current through the array of transmitters.

In one example of a device for monitoring a flowmeter, the driver is a metal-oxide-semiconductor field-effect transistor (MOSFET) or a programmable reference resistor.

In one example of a device for monitoring a flowmeter, the driver is configured to track current changes in the transmitters.

In one example of a device for monitoring a flowmeter, the driver is configured to periodically drive the transmitters to send the signals through the flowmeter.

In one example of a device for monitoring a flowmeter comprises, a memory configured to store the sensor data regarding which sensors of the array of sensors received the signal from the corresponding transmitter.

In one example there is provided a system for monitoring a flowmeter, comprising: a flowmeter with a float wherein a position of the float within the flowmeter indicates a rate of flow; an array of transmitters configured to transmit signals through the flowmeter; a first housing configured to house the array of transmitters; an array of sensors configured to receive the signals from the array of transmitters, wherein at least one signal from one of the array of transmitters is blocked by a float of the flowmeter; a memory configured to store sensor data regarding which sensors of the array of sensors received the signals and which sensors did not receive a signal; and a communication device configured to send the sensor data.

In one example of a system for monitoring a flowmeter, the transmitters are positioned along a length of the flowmeter and the sensors are positioned on an opposite side of the flowmeter corresponding to the transmitters such that the signals travel in a direction perpendicular to the length of the flowmeter.

In one example of a system for monitoring a flowmeter, the transmitters are positioned with a space in between one another where the space is the thickness of the float and sensor are spaced corresponding the transmitters.

In one example of a system for monitoring a flowmeter, the sensors are recessed into the second housing to block ambient signals not originating from the transmitters.

In one example of a system for monitoring a flowmeter, the first housing and the second housing are configured to mount to an existing flowmeter without disconnecting the flowmeter.

In one example of a system for monitoring a flowmeter, the first housing and the second housing are integrated into the flowmeter during the manufacture of the flowmeter.

In one example of a system for monitoring a flowmeter, the transmitters, the sensor, the first housing, and the second housing are positioned on the flowmeter such that a position of the float of the flowmeter is able to be visually read.

In one example of a system for monitoring a flowmeter, the transmitters are Light Emitting Diodes (LEDs) and the signals are light.

In one example of a system for monitoring a flowmeter, the transmitters are lasers and the signals are light.

In one example of a system for monitoring a flowmeter, the transmitters are ultrasonic transmitters and the signals are sound.

In one example of a system for monitoring a flowmeter, the sensors are phototransistors.

In one example of a system for monitoring a flowmeter, the signals are infrared (IR) light.

In one example of a system for monitoring a flowmeter comprises, a driver configured to drive current through the array of transmitters.

In one example of a system for monitoring a flowmeter, the driver is a metal-oxide-semiconductor field-effect transistor (MOSFET) or a programmable reference resistor.

In one example of a system for monitoring a flowmeter, the driver is configured to track current changes in the transmitters.

In one example of a system for monitoring a flowmeter, the driver is configured to periodically drive the transmitters to send the signals through the flowmeter.

In one example there is provided, a method for monitoring a flowmeter comprising: transmitting a signal from a transmitter through a flowmeter; receiving the signal at a sensor if the signal is not blocked by a float of the flowmeter; receiving no signal at the sensor if the signal is blocked by the float of the flowmeter; recording sensor data regarding whether the signal was received by the sensor; and sending the sensor data to a receiver.

In one example of a method for monitoring a flowmeter, the method further comprises periodically driving the transmitter to periodically send the signal through the flowmeter.

In one example of a method for monitoring a flowmeter, the method further comprises the transmitting the signal in a direction of travel that is perpendicular to a length of the flowmeter.

In one example of a method for monitoring a flowmeter, the method further comprises the transmitter is a Light Emitting Diode (LED) and the signal is light.

In one example of a method for monitoring a flowmeter, the method further comprises the transmitter is a laser and the signal is light.

In one example of a method for monitoring a flowmeter, the method further comprises the transmitter is an ultrasonic transmitter and the signal is sound.

In one example of a method for monitoring a flowmeter, the method further comprises the sensor is a phototransistor.

In one example of a method for monitoring a flowmeter, the method further comprises the signal is infrared (IR) light.

In one example of a method for monitoring a flowmeter, the method further comprises tracking a current change in the transmitter.

1-62. (canceled)

63. A flowmeter, comprising:
a housing having a first side and a second side;
first transmitters secured on the first side and second transmitters secured on the second side;
first sensors secured on the first side and second sensors secured on the second side, the first transmitters alternately located adjacent to the first sensors on the first side, and the second transmitters alternately located adjacent to the second sensors on the second side, respective ones of the first transmitters on the first side positioned opposite to corresponding ones of the second sensors on the second side, and respective ones of the second transmitters on the second side positioned opposite to the first sensors on the first side; and
recessed portions of the housing structured to (a) block ambient signals not originating from the respective first and second transmitters and the corresponding ones of the first and second sensors, (b) permit first intended signals from the respective ones of the first transmitters to the corresponding ones of the second sensors, and (c) permit second intended signals from the respective ones of the second transmitters to the corresponding ones of the first sensors.

64. The flowmeter as defined in claim 63, wherein the first transmitters alternately located adjacent to the first sensors on the first side are separated by a distance based on a float dimension.

65. The flowmeter as defined in claim 63, wherein (a) the first transmitters and the first sensors on the first side and (b) the second transmitters and the second sensors on the second side are vertically spaced depending on a dimension of a float in the flowmeter, the float to block at least one of (i) first intended signals from reaching respective ones of the first or (ii) second oppositely positioned sensors.

66. The flowmeter as defined in claim 63, wherein the first transmitters include Light Emitting Diodes (LEDs) and the first intended signals emitted by the first transmitters are light, and the second transmitters include lasers and the second intended signals emitted by the second transmitters are light.

67. The flowmeter as defined in claim 66, wherein the first and second sensors are phototransistors.

68. The flowmeter as defined in claim 63, wherein the first transmitters include ultrasonic transmitters and the first intended signals emitted by the first transmitters are sound, and the second transmitters include lasers and the second intended signals emitted by the second transmitters are light.

69. The flowmeter as defined in claim 63, further including:
a float; and
a communicator to transmit a signal to a base station when the float is at a target level.

70. The flowmeter as defined in claim 69, wherein the communicator is to conserve power by operating intermittently.

71. The flowmeter as defined in claim 63, further including an array structure, the first transmitters and the first sensors of the first side mounted in the array structure.

72. A method for monitoring a flowmeter, comprising:
transmitting first intended signals from first transmitters, the first transmitters secured on a first side of a housing;
transmitting second intended signals from second transmitters, the second transmitters secured on a second side of the housing;
monitoring for the first intended signals via first sensors secured on the second side of the housing, respective ones of the first sensors alternately adjacent to respective ones of the second transmitters;
monitoring for the second intended signals via second sensors secured on the first side of the housing, respective ones of the second sensors alternately adjacent to respective ones of the first transmitters,
blocking ambient signals from reaching the first and second sensors with recessed portions of the housing; and
permitting the first and second intended signals when a signal path between the first and second transmitters is in a perpendicular path to respective first and second sensors.

73. The method as defined in claim 72, wherein the first transmitters are alternately located adjacent to the first sensors on the first side, the first transmitters separable by a distance based on a float dimension.

74. The method as defined in claim 72, wherein (a) the first transmitters and the first sensors on the first side and (b) the second transmitters and the second sensors on the second side are vertically spaced based on a dimension of a float in the flowmeter, the float to block at least one of (i) first intended signals from reaching respective ones of the first or (ii) second oppositely positioned sensors.

75. The method as defined in claim 72, further including transmitting the first intended signals as first light signals, the first light signals emitted by Light Emitting Diodes (LEDS) and transmitting the second intended signals as second light signals, the second light signals emitted by lasers.

76. The method as defined in claim 75, wherein the first and second sensors are phototransistors.

77. The method as defined in claim 72, further including transmitting the first intended signals as acoustic signals, the acoustic signals emitted by ultrasonic transmitters, and transmitting the second intended signals as light signals, the light signals emitted by the second transmitters as light.

78. The method as defined in claim 72, further including transmitting a signal to a base station when the float is at a target a level through the use of a communicator.

79. The method as defined in claim 78, further including operating the communicator intermittently to conserve power.

80. The method as defined in claim 72, wherein the first transmitters and the first sensors of the first side are mounted to an array structure.
